(19) United States
(12) Patent Application Publication
(10) Pub. No.: US 2025/0054652 A1
(43) Pub. Date: Feb. 13, 2025

(54) LOW-COHERENCE TERAHERTZ ILLUMINATION SOURCE FOR IMAGING APPLICATIONS

(71) Applicant: INSTITUT NATIONAL D’OPTIQUE, Québec (CA)

(72) Inventors: Alex PAQUET, Québec (CA); Michel DOUCET, Québec (CA)

(73) Assignee: INSTITUT NATIONAL D’OPTIQUE, Québec (CA)

(21) Appl. No.: 18/719,238

(22) PCT Filed: Dec. 13, 2022
(86) PCT No.: PCT/CA2022/051813

§ 371 Date: Jun. 12, 2024

Related U.S. Application Data
(60) Provisional application No. 63/265,616, filed on Dec. 17, 2021.

(51) Int. Cl. G21K 5/00

(52) U.S. Cl. CPC G21K 5/00

(57) ABSTRACT

An illumination source emitting low-coherence electromagnetic radiation in the terahertz (THz) frequency range is disclosed. The source includes a THz radiation emitter that emits input THz radiation and an enclosure forming a cavity coupled to the THz radiation emitter. The enclosure includes an inner wall enclosing the cavity and having a reflective surface that reflects the input THz radiation within the cavity as circulating THz radiation, and an optical output port that allows a portion of the circulating THz radiation to exit from the cavity as output THz radiation after multiple reflections off the reflective surface, the output THz radiation having a reduced coherence compared to that of the input THz radiation. The source also includes an optical perturbation element that acts on the input or circulating THz radiation to contribute, along with the multiple reflections off the reflective surface, to achieving the reduced coherence of the output THz radiation.

### RELATED PATENT APPLICATION

The present application claims priority to U.S. Provisional Patent Application No. 63/265,616 filed on Dec. 17, 2021, the disclosure of which is incorporated herein by reference in its entirety.

### TECHNICAL FIELD

The technical field generally relates to sources of electromagnetic radiation, and more particularly to illumination sources for imaging applications and emitting in the terahertz (THz) frequency range.

### BACKGROUND

Many types of THz radiation sources exist, and their operation is based on various emission mechanisms, technologies, and processes. Conventional THz radiation sources generally emit coherent or partially coherent radiation, which can be a drawback in certain imaging applications. This is because coherent THz illumination sources can produce interference fringe artifacts and other unwanted coherence-related noise in THz images. Challenges remain in the development of THz illumination sources having reduced coherence.

### SUMMARY

The present description generally relates to THz illumination sources having reduced coherence.

In accordance with an aspect, there is provided a low-coherence THz illumination source for THz imaging applications, the low-coherence THz illumination source including:
a THz radiation emitter configured to emit input THz radiation;
   an enclosure forming a cavity optically coupled to the THz radiation emitter, the enclosure including:
      an inner wall enclosing the cavity and having a reflective surface configured to reflect the input THz radiation within the cavity as circulating THz radiation; and
      an optical output port configured to allow a portion of the circulating THz radiation to exit from the cavity as output THz radiation after multiple reflections off the reflective surface, the output THz radiation having a reduced coherence compared to a coherence of the input THz radiation; and
an optical perturbation element configured to act on the input THz radiation or the circulating THz radiation to contribute, along with the multiple reflections off the reflective surface, to achieving the reduced coherence of the output THz radiation.

Depending on the application, the optical perturbation element may be configured to act on only the input THz radiation, only the circulating THz radiation, or the input THz radiation and the circulating THz radiation.

In some embodiments, the THz radiation emitter includes a single radiation-emitting element. In other embodiments, the THz radiation emitter includes a plurality of radiation-emitting elements, wherein the plurality of radiation-emitting elements may or may not be identical to one another.

In some embodiments, the THz radiation emitter is located inside the cavity.

In some embodiments, the THz radiation emitter is located outside the cavity, and the enclosure further includes an optical input port optically coupled to the THz radiation emitter and configured to allow the input THz radiation to enter into the cavity. In some embodiments, the THz radiation emitter is coupled to optical input port via waveguide coupling. For example, the low-coherence THz illumination source may further include an input optical waveguide configured to couple the input THz radiation emitted by THz radiation emitter into the optical input port. In some embodiments, the THz radiation emitter is coupled to the at least one optical input port via free-space optics. In some embodiments, a cross-sectional area of the optical input port is smaller than a cross-sectional area of the optical output port.

In some embodiments, the optical input port is a single optical input port through which the input THz radiation is configured to enter into the cavity. In other embodiments, the optical input port is one of a plurality of optical input ports, each of which allowing a respective portion of the input THz radiation to enter into the cavity.

In some embodiments, the low-coherence THz illumination source further includes a polarizer arranged in the cavity in front of the optical input port and having a reflection axis, the polarizer being configured to prevent a polarization component of the circulating THz radiation oriented along the reflection axis from exiting the cavity through the optical input port.

In some embodiments, the optical perturbation element includes beam-injection optics or beam-shaping optics disposed outside the enclosure along a path of the input THz radiation between the THz radiation emitter and the optical input port.

In some embodiments, the optical perturbation element is located inside the enclosure. In some embodiments, the optical perturbation element is disposed on the inner wall of the enclosure to act on the circulating THz radiation as the circulating THz radiation is reflected off the reflective surface. In some embodiments, the optical perturbation element is positioned away from the inner wall of the enclosure to act on the circulating THz radiation between the multiple reflections of the circulating THz radiation off the reflective surface. In some embodiments, the optical perturbation element includes a movable mirror.

In some embodiments, the optical perturbation element is one of a plurality of optical perturbation elements.

In some embodiments, the enclosure is spherical. In some embodiments, the cavity is a spherical cavity. Depending on the application, the exterior shape of the enclosure may or may not match the shape of the cavity.

In some embodiments, the enclosure is a single enclosure. In other embodiments, the enclosure is one of a plurality of enclosures and the cavity is one of a plurality of cavities formed by the plurality of enclosures, and the low-coherence THz illumination source includes at least one inter-enclosure optical link for optically connecting the cavities together. In some embodiments, the at least one inter-enclosure optical link includes an inter-enclosure optical waveguide. The enclosures may or may not be identical to one another.

In some embodiments, the enclosure includes a single optical output port configured to output the output THz radiation. In other embodiments, the enclosure includes a plurality of optical output ports through which the output THz radiation escapes from the enclosure.

Depending on the application, the reflective surface may cover all or a portion of the inner wall of the enclosure.

In some embodiments, the optical perturbation element is a single optical perturbation element. In other embodiments, the optical perturbation element is one of a plurality of optical perturbation elements, which may or may not be identical to one another.

In some embodiments, the optical perturbation element is configured to apply a static (or steady) optical perturbation to the input THz radiation or the circulating THz radiation.

In some embodiments, the optical perturbation element is configured to apply a dynamic (or time-varying) optical perturbation to the input THz radiation or the circulating THz radiation. In some embodiments, the optical perturbation element is configured to apply the dynamic optical perturbation to a drive signal of the THz radiation emitter. In some embodiments, the optical perturbation element is configured to modulate the drive signal of the THz radiation emitter to dynamically sweep a center frequency of the input THz radiation over a range of frequencies.

In some embodiments, the optical perturbation element is configured to apply both a static and a dynamic optical perturbation to the input THz radiation or the circulating THz radiation. In some embodiments, the low-coherence THz illumination source may include both at least one static optical perturbation element and at least one dynamic optical perturbation element.

In some embodiments, the optical perturbation element is configured to act on at least one of an intensity spectrum (e.g., its shape, bandwidth, center frequency or wavelength), a state of polarization, a distribution of propagation directions, or a phase of the input THz radiation or the circulating THz radiation.

The optical perturbation element may be configured to act on the input THz radiation or the circulating THz radiation at any point of the optical path extending from the THz radiation emitter and the optical output port. In such embodiments, if the THz radiation emitter is disposed inside the enclosure, the optical perturbation element is also disposed inside the enclosure, either on the inner wall or at another location within the volume of the cavity that intercepts the multiple-reflection path followed by the circulating THz radiation. In the former case, the optical perturbation element can include diffractive, optically diffusing, scattering, polarization-changing, and/or birefringent elements disposed on the inner wall to increase the ray trajectory diversity of the multiple-reflection process or change ray properties. In the latter case, the optical perturbation element can include reflective, refractive, diffractive, or diffusing elements disposed in the cavity to change the trajectory or the properties of the circulating THz radiation between successive reflections off the reflective surface. More specific examples of such possible optical elements include movable (e.g., oscillating or rotating) mirrors, either single-faceted or multifaceted; oscillating or rotating diffractive or optically diffusing elements; vibrating reflective membranes; and oscillating or rotating elements made of isotropic or anisotropic transparent materials.

In some embodiments, if the THz radiation emitter is disposed outside the enclosure, the optical perturbation element may be disposed either inside or outside the enclosure. In the latter case, the optical perturbation element can be provided within the optical input port of the enclosure or at another appropriate location along the path of the input THz radiation prior to its entry into the enclosure. For example, the optical perturbation element can be provided in beam-injection optics and/or beam-shaping optics disposed between the THz radiation emitter and the optical input port of the enclosure. Non-limiting examples of beam-injection optics that can include, or act as, optical perturbation elements include rotating or scanning mirror systems configured to inject the input THz radiation at different angles into the optical input port, rotating diffusing elements, rotating prisms, counter-rotating prism pairs, vibrating reflective membranes, and waveguiding optics. Non-limiting examples of beam-shaping optics that can include, or act as, optical perturbation elements configured to change the intensity and/or direction of rays forming the input THz radiation include various types of reflective, refractive, and diffractive beam-shaping systems, whether static or dynamic.

Other features and advantages of the present description will become more apparent upon reading of the following non-restrictive description of specific embodiments thereof, given by way of example only with reference to the appended drawings. Although specific features described in the above summary and the foregoing detailed description may be described with respect to specific embodiments or aspects, it should be noted that these specific features can be combined with one another, unless stated otherwise.

### BRIEF DESCRIPTION OF THE DRAWINGS

FIG. 1 is a schematic perspective view of an embodiment of a low-coherence THz illumination source.

FIG. 2 is a partially cutaway perspective view of the low-coherence THz illumination source of FIG. 1.

FIG. 3 is a cross-sectional elevation view of the low-coherence THz illumination source of FIG. 1, taken along section line 3-3 in FIG. 1.

FIG. 4 is a schematic cross-sectional elevation view of another embodiment of a low-coherence THz illumination source.

FIGS. 5A to 5C are schematic perspective views of three embodiments of a low-coherence THz illumination source corresponding to three different arrangements for the optical input and output ports.

FIGS. 6A to 6E are schematic representations of examples of enclosures having an optical input port, an optical output port, and cavities with different shapes: sphere (FIG. 6A); hemisphere (FIG. 6B); parallelepiped (FIG. 6C); half-mushroom (FIG. 6D); and C-shaped (FIG. 6E).

FIGS. 7A to 7D are schematic representations of four embodiments of a low-coherence THz illumination source having a plurality of enclosures forming a corresponding plurality of cavities optically coupled by at least one inter-enclosure optical link: double-sphere configuration in which the two spherical enclosures are coupled by an optical interface (FIG. 7A); a triple-sphere configuration in which the three spherical enclosures are coupled by two optical interfaces (FIG. 7B); a parallelepiped-sphere configuration where the spherical enclosure and the parallelepipedal enclosure are coupled by an optical interface (FIG. 7C); and a double-sphere configuration in which the two spherical enclosures are coupled together by an optical waveguide or light pipe (FIG. 7D).

FIGS. 8A and 8B illustrate examples of static optical perturbation elements disposed on the inner wall of the enclosure of a low-coherence THz illumination source.

FIG. 9 is a schematic, partially cutaway, perspective view of an embodiment of a low-coherence THz illumination source including an optical perturbation element located inside the cavity.

FIG. 10 is a schematic, partially cutaway, perspective view of another embodiment of a low-coherence THz illumination source including an optical perturbation element located inside the cavity.

FIG. 11 is a schematic representation of a dynamic optical perturbation element embodied by an electrically controllable liquid-crystal layer, in accordance with an embodiment.

FIGS. 12A and 12B are schematic cross-sectional elevation views of embodiments of a low-coherence THz illumination source including a dynamic optical perturbation element embodied by beam-injection optics.

FIG. 13 depicts a schematic representation of a static optical perturbation element embodied by an inverse Cassegrain mirror system, in accordance with an embodiment.

FIG. 14 depicts a schematic representation of a static optical perturbation element embodied by a two-mirror system, in accordance with an embodiment.

FIG. 15 depicts a schematic representation of a static optical perturbation element embodied by beam-shaping optics including an axicon, in accordance with an embodiment.

FIG. 16 depicts a schematic representation of a dynamic optical perturbation element including a rotating wedged refractive element, in accordance with an embodiment.

FIG. 17 depicts a schematic representation of a dynamic optical perturbation element including a wobbling rotating mirror, in accordance with an embodiment.

FIG. 18 is a schematic perspective view of an embodiment of a low-coherence THz illumination source including optical input ports configured to couple input THz radiation into the enclosure via waveguide coupling.

FIG. 19 is a schematic perspective view of an embodiment of a low-coherence THz illumination source including a polarizer in front of the optical input port.

FIG. 20 is a schematic perspective view of an embodiment of a low-coherence THz illumination source including a inverted compound parabolic concentrator connected at the optical output port.

FIG. 21 is a schematic cross-sectional elevation view of an embodiment of a low-coherence THz illumination source including a pair of enclosures and an optical perturbation element disposed in an inter-enclosure optical link connecting the enclosures.

FIG. 22A is a schematic representation of an image of a resolution target having a Siemens star pattern. FIG. 22B is a representation of an image of the resolution target of FIG. 22A captured using a coherent THz illumination source. FIG. 22C is a representation of an image of the resolution target of FIG. 22A captured using an embodiment of a low-coherence THz illumination source.

### DETAILED DESCRIPTION

In the present description, similar features in the drawings have been given similar reference numerals. To avoid cluttering certain figures, some elements may not be indicated if they were already identified in a preceding figure. The elements of the drawings are not necessarily depicted to scale, since emphasis is placed on clearly illustrating the elements and structures of the present embodiments. Positional descriptors indicating the location and/or the orientation of one element with respect to another element are used herein for ease and clarity of description. Unless otherwise indicated, these positional descriptors should be taken in the context of the figures and should not be considered limiting. Such spatially relative terms are intended to encompass different orientations in the use or operation of the present embodiments, in addition to the orientations exemplified in the figures. Furthermore, when a first element is referred to as being “on”, “above”, “below”, “over”, or “under” a second element, the first element can be either directly or indirectly on, above, below, over, or under the second element, respectively, such that one or multiple intervening elements may be disposed between the first element and the second element.

The terms “a”, “an”, and “one” are defined herein to mean “at least one”, that is, these terms do not exclude a plural number of elements, unless stated otherwise.

The term “or” is defined herein to mean “and/or”, unless stated otherwise.

Terms such as “substantially”, “generally”, and “about”, which modify a value, condition, or characteristic of a feature of an exemplary embodiment, should be understood to mean that the value, condition, or characteristic is defined within tolerances that are acceptable for the proper operation of this exemplary embodiment for its intended application or that fall within an acceptable range of experimental error. In particular, the term “about” generally refers to a range of numbers that one skilled in the art would consider equivalent to the stated value (e.g., having the same or equivalent function or result). In some instances, the term “about” means a variation of +10% of the stated value. It is noted that all numerical values used herein are assumed to be modified by the term “about”, unless stated otherwise.

The terms “connected” and “coupled”, and derivatives and variants thereof, are intended to refer herein to any connection or coupling, either direct or indirect, between two or more elements, unless stated otherwise. For example, the connection or coupling between the elements may be mechanical, optical, electrical, magnetic, thermal, chemical, logical, fluidic, operational, or any combination thereof.

The present description generally relates to low-coherence illumination sources for THz imaging applications.

The terms “light” and “optical”, and variants and derivatives thereof, are intended to refer herein to radiation in any appropriate region of the electromagnetic spectrum. In particular, these terms are not limited to visible light. The term “terahertz radiation” refers herein to electromagnetic radiation having a center wavelength ranging from about 30 μm to about 3 mm, corresponding to center frequencies ranging from about 0.1 THz to about 10 THz. However, it is appreciated that the definition of the term “terahertz radiation” in terms of a particular spectral range may vary depending on the technical field or standard under consideration, and is not meant to limit the scope of application of the present techniques.

Terahertz radiation can penetrate through materials that are opaque to visible light, such as clothing and cardboard boxes, while being safe for humans and animals, contrary to X-ray radiation. Optical sensors and systems using THz radiation sources, or operating with THz radiation, can perform see-through imaging in various commercial and industrial applications. Non-limiting examples of such applications include non-destructive inspection, concealed object detection, and other security applications.

Conventional sources of THz radiation generally emit coherent or partially coherent radiation. Although the coherence characteristics of the radiation emitted by conventional THz sources are comparable to those of visible-wavelength and near-infrared-wavelength lasers, the wavelength of the radiation is orders of magnitude larger. The coherence of a laser beam can be reduced to some extent by transmitting it through a moving optical diffuser, diffractive optics, or microlenses. Another approach is to use the output of an integrating sphere having its internal wall painted with a high-reflectance optically diffusing coating layer. In the THz spectral range, those approaches are difficult to implement for several reasons.

One challenge is the scale of the optically diffusing elements. In some applications, hundreds of thousands or even millions of optically diffusing sites or elements, each of them having a size comparable to the radiation wavelength, can be required to produce a satisfying scattering effect. For example, at a wavelength of one millimeter, implementing those approaches can involve surface areas of the order of one square meter. In such applications, large (if not oversized) optics are used to expand THz radiation beams to the size of the optically diffusing element, and additional optics are used to gather the diffused rays. The passage of a coherent light beam through an optical diffuser generally produces a granular and chaotic intensity distribution over the volume occupied by the diffused beams. Such an intensity distribution caused by the interference of a large number of rays with random phase differences is referred to as a speckle pattern or speckle noise. Speckle patterns can be observed in free-space propagation of a diffused coherent beam or in the image plane of an active imaging system. Except for speckle patterns that are significantly smaller than the imaging pixels, speckle noise is generally considered as a nuisance that degrades the quality and interpretability of images.

In some implementations, the granular aspect of speckle patterns can be attenuated or practically eliminated through rapid changes in the optical paths. In the case of illumination systems, moving the optically diffusing element is generally sufficient to control speckle noise. For imaging applications, the displacements of the optically diffusing element should be large and fast enough to produce a large number of distinct (i.e., statistically independent) speckle patterns over the exposure time of each image frame. In the case of THz video images, this approach involves large and rapid motion of a large and heavy optically diffusing element, which can be challenging to implement in practice.

The intensity distribution of a speckle pattern depends on the diffusion process responsible for the generation of the random optical path lengths of the rays. In the case of a fully developed speckle pattern, where the dark and bright grains of the pattern are small and highly contrasted, the pattern can be very sensitive to any changes in the diffusion process. When the conditions of a fully developed speckle pattern are achieved in an illumination system with an optically diffusing element, a displacement of the optically diffusing element corresponding to a fraction of the size of the illuminated area is generally sufficient to significantly change the speckle pattern. However, even under such facilitated conditions, smoothing of a speckle pattern by displacement of an optically diffusing element remains challenging in the THz spectral range due to the large size and heavy weight of the optically diffusing element.

Various aspects, features, and implementations of the present techniques are described below with reference to the figures.

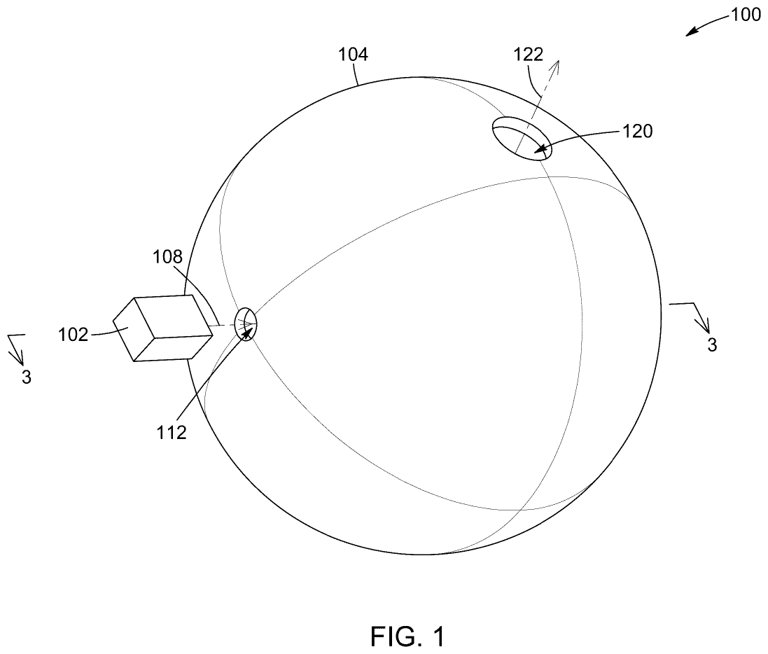

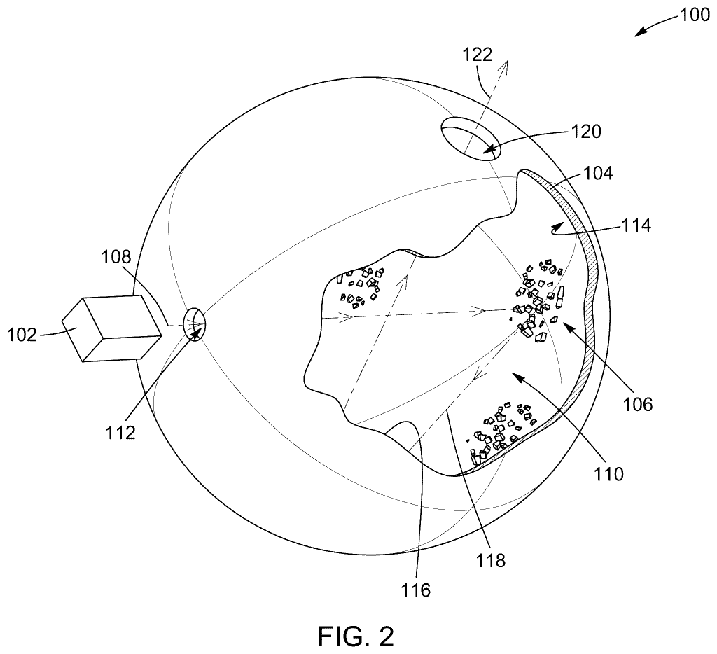

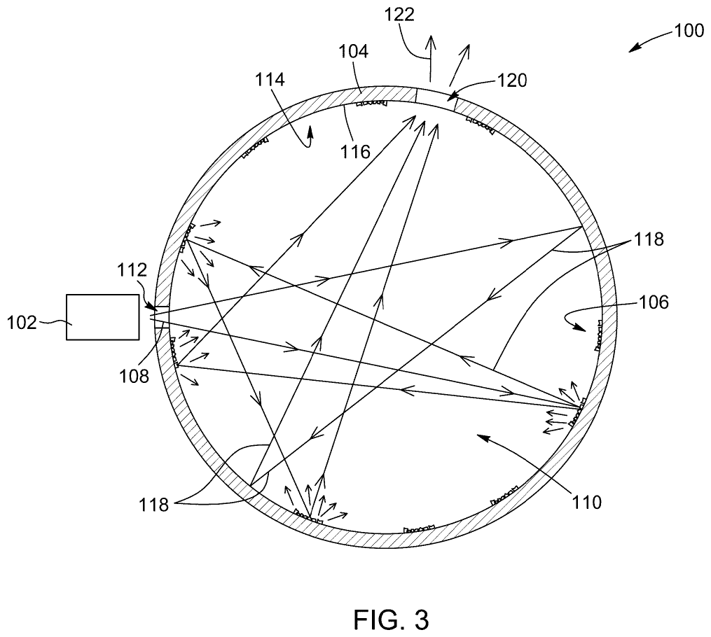

Referring to FIGS. 1 to 3, there are illustrated schematic views of a possible embodiment of a low-coherence THz illumination source 100. The THz illumination source 100 can be used in various imaging applications. The THz illumination source 100 generally includes a THz radiation emitter 102, an enclosure 104, and an optical perturbation element 106. The THz radiation emitter 102 is configured to emit input THz radiation 108. The enclosure 104 forms a cavity 110 that is optically coupled to the THz radiation emitter 102. In this embodiment the THz radiation emitter 102 is located outside the cavity 110. The enclosure 104 includes an optical input port 112 optically coupled to the THz radiation emitter 102 and configured to allow the input THz radiation 108 to enter into the cavity 110. The enclosure 104 also includes an inner wall 114 enclosing the cavity 110 and having a reflective surface 116 configured to reflect the input THz radiation 108 within the cavity 110 as circulating THz radiation 118. The enclosure 104 further includes an optical output port 120 configured to allow a portion of the circulating THz radiation 118 to exit from the cavity 110 as output THz radiation 122 after multiple reflections of the circulating THz radiation 118 off the reflective surface 116. The output THz radiation 122 has a reduced coherence compared to that of the input THz radiation 108. The optical perturbation element 106 is configured to act on the input THz radiation 108 and/or the circulating THz radiation 118 to contribute, along with the multiple reflections off the reflective surface 116, to achieving the reduced coherence of the output THz radiation 122. To avoid cluttering, only a very few number of light rays associated to the circulating THz radiation 118 have been schematically illustrated in FIGS. 2 and 3. The structure, composition, and operation of these and other possible components of the THz illumination source 100 are described in greater detail below.

It is appreciated that FIGS. 1 to 3 are simplified schematic representations that illustrate a number of features and components of the THz illumination source 100, such that additional features and components that may be useful or necessary for its proper operation may not be specifically depicted. Non-limiting examples of such additional features and components may include various optical components configured to act on the input THz radiation 108 or the output THz radiation 122.

The THz radiation emitter 102 may be embodied by any appropriate device or combination of devices configured to generate the input THz radiation 108, generally as coherent or partially coherent radiation. Various types of THz radiation sources can be used as the THz radiation emitter 102. Non-limiting examples of THz sources include thermal sources, vacuum electronic sources, solid-state electronic sources, and direct and indirect laser sources. More specific examples include, to name a few, Gunn, IMPATT, and Schottky diodes, with or without frequency multipliers or resonant tunneling diodes (RTD); silicon complementary metal-oxide-semiconductor (Si-CMOS) transistors and field-effect transistor-based sources; SiGe and other heterojunction bipolar transistors (HBTs); high-electron-mobility transistors (HEMTs); photomixing sources; and quantum cascade laser (QCL) sources. It is appreciated that the theory, configuration, implementation, and operation of THz sources are generally known in the art and need not be described in detail herein other than to facilitate an understanding of the present techniques.

In some embodiments, the THz radiation emitter 102 includes a single radiation-emitting element. In other embodiments, the THz radiation emitter 102 includes a plurality of radiation-emitting elements provided, for example, in an array format. In such embodiments, the THz radiation emitter 102 can have individual beam-shaping elements associated with the radiation-emitting elements, and collective beam-shaping elements. Referring is made in this regard to co-assigned U.S. Pat. Appl. Pub. No. 2021/0055624, the contents of which are incorporated herein by reference in their entirety. It is appreciated that in embodiments where the THz radiation emitter 102 includes a plurality of radiation-emitting elements, the individual radiation-emitting elements may or may not differ from one another.

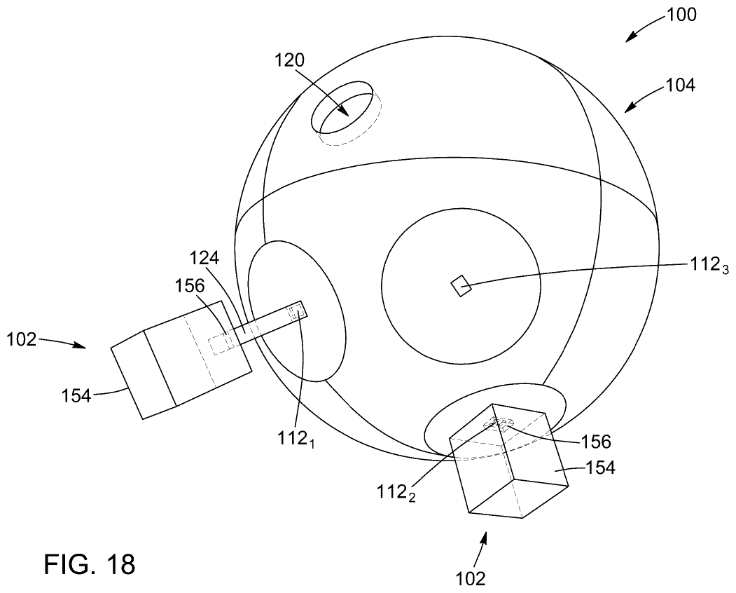

In some embodiments, the THz radiation emitter 102 can be coupled to the optical input port 112 via waveguide coupling. In such embodiments, the THz illumination source 100 can include an input optical waveguide 124 configured to couple the input THz radiation 108 emitted by the THz radiation emitter 102 into the optical input port 112, as depicted in FIGS. 18 to 20, which are described in greater detail below.

In some embodiments, the THz radiation emitter 102 can be coupled to the optical input port 112 via free-space optics. For example, the THz radiation emitter 102 can be configured to emit directly in free space using antennas. Various types of antenna designs can be used. Non-limiting examples include, to name a few, horn antennas (e.g., diagonal horn antennas, conical horn antennas, wide angle scalar feed horn antennas, corrugated horn antennas), bowtie antennas, dipole antennas, log-periodic antennas, and Vivaldi antennas. These various antenna designs generally have specific emission radiation patterns or beams, such as Gaussian or others.

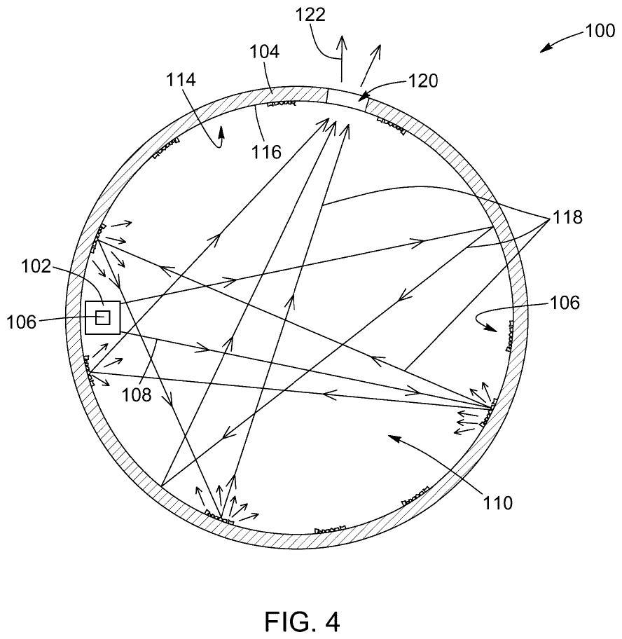

Referring to FIG. 4, there is illustrated another possible embodiment of a low-coherence THz illumination source 100. The embodiment of FIG. 4 shares several features with the embodiment of FIGS. 1 to 3, which will not be described again other than to highlight differences between them. In the embodiment of FIG. 4, the THz radiation emitter 102 is disposed inside the cavity 110 rather than outside the cavity 110 as in FIGS. 1 to 3. The THz radiation emitter 102 can be mounted inside the enclosure 104, for example, by affixing it to the inner wall 114 or by providing it at another location inside the cavity 110, using suitable mounting hardware. The THz radiation emitter 102 can be powered via appropriate electrical feedthroughs. By disposing the THz radiation emitter 102 within the cavity 110, the enclosure 104 of the THz illumination source 100 of FIG. 4 need not include an optical input port as in the embodiment of FIGS. 1 to 3.

Returning to FIGS. 1 to 3, the reflective surface 116 of the inner wall 114 of the enclosure 104 is configured to reflect the input THz radiation 108 multiple times within the cavity 110 as the circulating THz radiation 118. In such a way, the rays forming the circulating THz radiation 118 can follow various ray trajectories or paths between the successive reflections. After having undergone a certain number of reflections, a portion of the circulating THz radiation 118 can escape from the cavity 110 through the optical output port 120, thereby forming the output THz radiation 122, which has a reduced coherence compared to that of the input THz radiation 108. The reflective surface 116 may cover all or a portion of the inner wall 114 of the enclosure 104.

The reflective surface 116 is configured to deconstruct the structured organization of the rays of the coherent or partially coherent input THz radiation 108 injected into the cavity 110. This deconstruction results in part from the numerous distinct possible ray trajectories that can be achieved depending on the ray injection conditions, for example, the position of the optical input port 112 with respect to the cavity 110 and the launching direction and spread angle of the input THz radiation 108 inside the cavity 110. It is appreciated that even a single enclosure 104 having a spherical cavity 110, a smooth mirror-like polished reflective surface 116, a single optical input port 112, and a single optical output port 120 can provide a large number of distinct possible ray trajectories. The number and characteristics of these ray trajectories can depend on a variety of factors, including the size, shape, and position of the optical input port 112, the size, shape, and position of the optical output port 120, and the manner in which the input THz radiation 108 is coupled and launched into the cavity 110. Any combinations of positions for the optical input port 112 and the optical output port 120 can generally be envisioned as long as they do not interfere with surrounding equipment, such as the supporting hardware for the enclosure 104. It is appreciated that while the embodiment of FIGS. 1 to 3 includes, for simplicity, a THz radiation emitter 102 with a single radiation-emitting element and an enclosure 104 with a single optical input port 112 and a single optical output port 120, this need not be the case in other embodiments. In general, the THz radiation emitter 102 can include u radiation-emitting element(s) and the enclosure 104 can include v optical input port(s) 112 and w optical output port(s) 120, where the numbers u, v, and w may or may not be identical to one another.

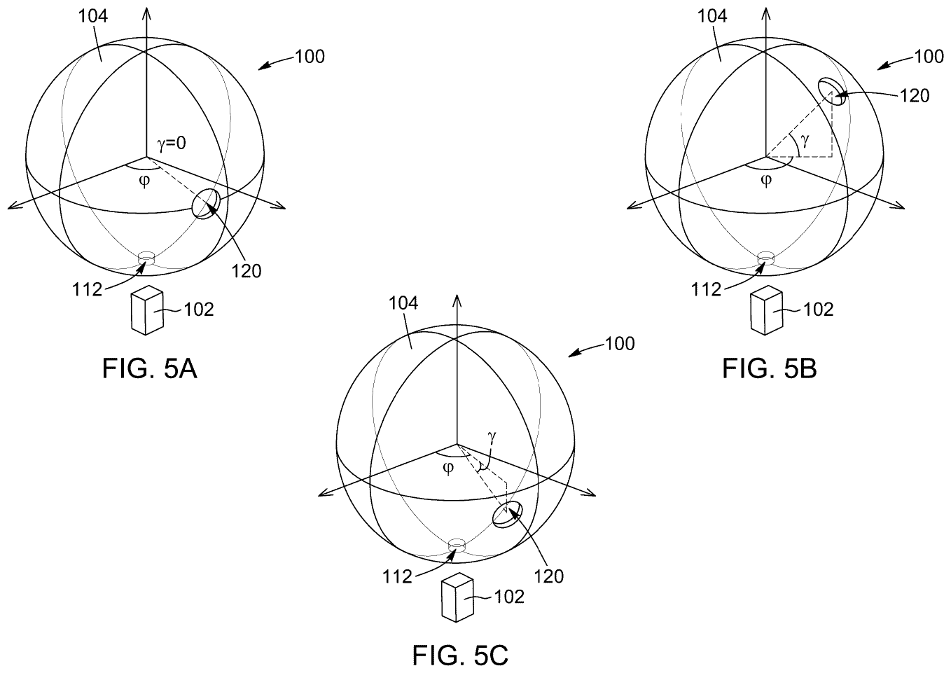

Referring to FIGS. 5A to 50, three embodiments of a single-enclosure THz illumination source 100 are illustrated, which correspond to three different arrangements for the optical input port 112 and the optical output port 120 on the single enclosure 104. The arrangements are characterized by three different combinations of the azimuthal and elevation angles (o, y) of the optical output port 120 with respect to the center position of the enclosure 104.

Returning to FIGS. 1 to 3, it may be desired or required in some implementations that the optical output port 120 is not in direct line of sight with the light cone of the input THz radiation 108 injected through the optical input port 112, as this could otherwise allow some rays to exit the enclosure 104 without complexifying their trajectories through multiple internal reflections within the cavity 110. In embodiments where the cavity 110 is spherical, the trajectories of a ray inside the cavity 110 are all contained in a same plane of incidence defined by the input ray line and the center position of the cavity 110, so as to form a cyclic equiangular polygon. The term “equiangular” means that all the corner angles of the polygon are equal, and the term “cyclic” means that corners of the polygon all lie on a same circle. The ray can exit the cavity 110 if the plane of incidence intersects the optical output port 120 and if the ray trajectory intersects the optical output port 120 prior to returning to the optical input port 112. It is appreciated that losses caused by rays exiting the enclosure 104 through the optical input port 112 should be minimized or at least kept under a certain threshold, which can be achieved by keeping the size of the optical input port 112 relatively small. Furthermore, since in practice the reflectivity of the reflective surface 116 is less than 100% at the frequency of the input THz radiation 108, the energy of the ray decreases accordingly after each reflection. Thus, if the number of reflections experienced by the ray prior to the ray exiting the cavity 110 exceeds a certain value, the ray may be too weak to contribute to the overall power carried by the output THz radiation 122.

The reflective surface 116 may be made of a variety of materials having a suitably high reflectivity for THz radiation. Non-limiting examples include various metals (e.g., aluminum, gold, silver, and nickel), as well as other materials such as graphite and paints containing metallic flakes. In some embodiments, the reflective surface 116 may be formed by depositing one or more layers of reflective materials on the inner wall 114 of the enclosure 104, for example, by painting, evaporation, electrodeposition in a bath, or by any other suitable deposition processes. In some embodiments, the reflective surface 116 may be covered with a thin protective layer. Obtaining THz reflective surfaces having a mirror-like specular surface finish is generally straightforward using standard machining or polishing processes, since residual asperities can have sub-millimetric sizes without producing significant amount of light scattering. By contrast, obtaining effective diffuse reflective surfaces at THz frequencies is often more challenging.

In some embodiments, the enclosure 104 may be fabricated from a piece of metal by bulk machining, or be molded in plastic or other materials. In some embodiments, additive manufacturing techniques, such as 3D printing of plastic or metallic materials, can be used to fabricate the enclosure 104.

It is appreciated that while the THz illumination source 100 depicted in FIGS. 1 to 3 includes a single spherical enclosure 104 having a spherical cavity 110, other embodiments may have more complex or otherwise different configurations.

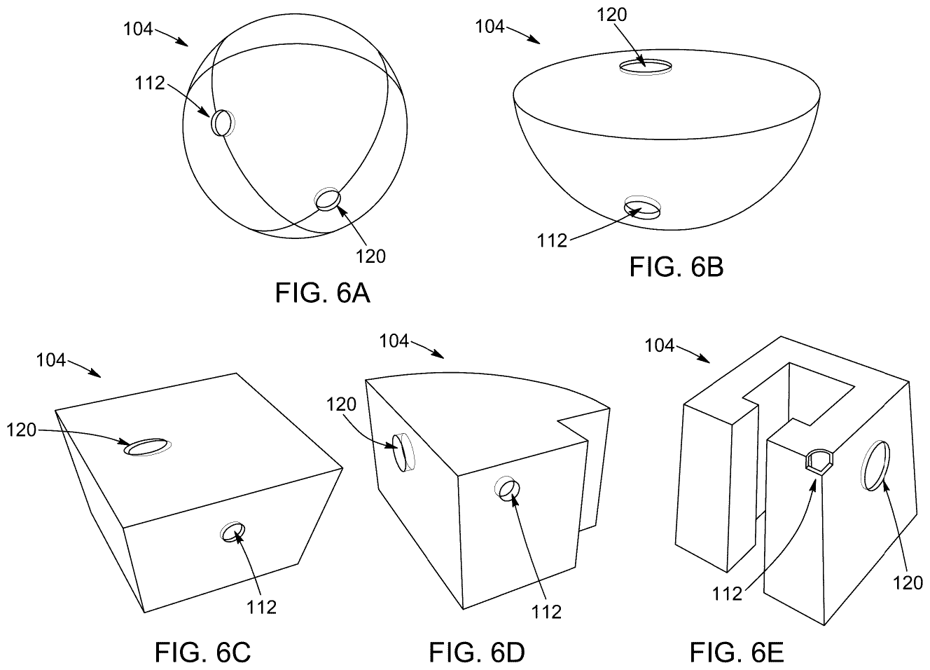

Referring to FIGS. 6A to 6E, non-limiting examples of enclosures 104 having an optical input port 112, an optical output port 120, and enclosures 104 with different cavity shapes are illustrated: sphere (FIG. 6A); hemisphere (FIG. 6B); parallelepiped (FIG. 6C); half-mushroom (FIG. 6D); and C-shaped (FIG. 6E).

In some embodiments, the exterior shape of the enclosure may not match the shape of the cavity. For example, the enclosure could have a spherical cavity but a cubic or rectangular prismatic exterior shape to facilitate handling, storage, or mounting in an imaging system.

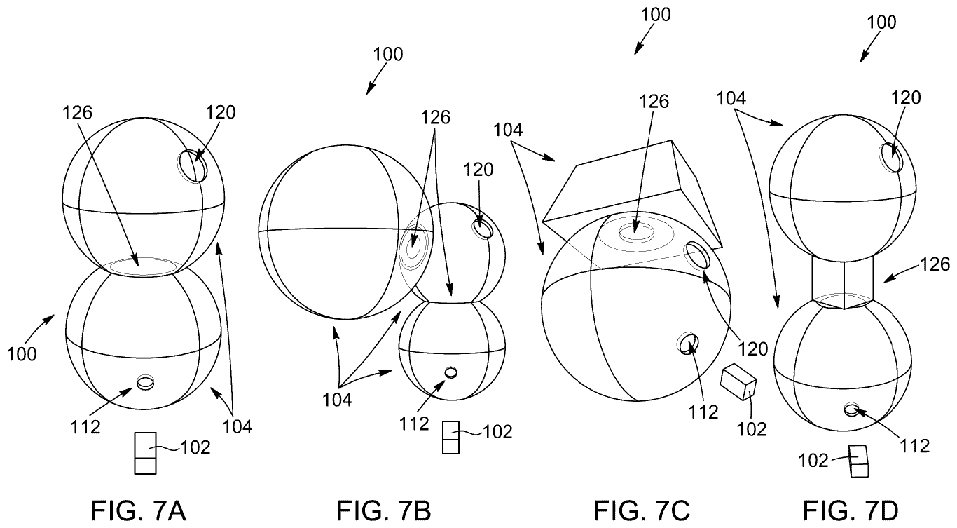

Referring to FIGS. 7A to 7D, in some embodiments the low-coherence THz illumination source 100 may include a plurality of enclosures 104 forming a corresponding plurality of cavities 110 optically coupled together by at least one inter-enclosure optical link 126. For example, the at least one inter-enclosure optical link 126 can be embodied by optical interfaces, optical waveguides or light pipes, or combinations thereof. It is appreciated that the size, shape, structure, and composition of each enclosure 104 and its corresponding cavity 110 can be individually tailored, depending on the application. In some embodiments, the cavity dimensions (e.g., diameter) are significantly larger than the wavelength of the input THz radiation 108. For example, in one embodiment the cavity 110 can be a sphere having a diameter ranging from about 20 mm to about 300 mm. Non-limiting examples of multi-enclosure configurations, each of which including an optical input port 112 and an optical output port 120, are illustrated in FIGS. 7A to 7D: a double-sphere configuration in which the two spherical enclosures 104 are coupled together by an inter-enclosure optical link 126 embodied by an optical interface (FIG. 7A); a triple-sphere configuration in which the three spherical enclosures 104 are coupled together by two inter-enclosure optical links 126 embodied by two optical interfaces (FIG. 7B); a parallelepiped-sphere configuration where one spherical enclosure 104 and one parallelepipedal enclosure 104 are coupled together by an inter-enclosure optical link 126 embodied by an optical interface (FIG. 7C); and a double-sphere configuration in which the two spherical enclosures 104 are coupled together by an inter-enclosure optical link 126 embodied by a rectangular optical waveguide or light pipe (FIG. 7D).

Compared to single-enclosure configurations, it is appreciated that more complex ray trajectories can generally be achieved with multi-enclosure configurations. For example, in the double-enclosure configuration illustrated in FIG. 7A, each spherical enclosure 104 is truncated by a plane to form a circular aperture, and the truncated enclosures 104 are coupled together by their apertures to define an optical interface forming the inter-enclosure optical link 126 therebetween. In such a configuration, rays are allowed to pass between the enclosures 104 via the inter-enclosure optical interface (or via an inter-enclosure optical waveguide or light pipe, as in FIG. 7D). Inter-enclosure optical interfaces can be circular or have any other suitable shapes. In some embodiments, a plurality of inter-enclosure optical links 126 (e.g., optical interfaces, waveguides and/or light pipes) may be provided to allow rays to travel between two enclosures 104. At least one optical input port 112 can be provided on either or both of the enclosures 104 as in FIGS. 7A to 7D, and likewise for the at least one optical output port 120. The two-enclosure configurations of FIGS. 7A, 7C, and 7D can be generalized to a cascade of enclosures 104 (e.g., a cascade of three or more enclosures 104, as depicted in FIG. 7B) optically coupled together through various combinations of inter-enclosure optical links 126, with any suitable number and disposition of optical input ports 112 and optical output ports 120. It is appreciated that, in general, the greater the number of enclosures and inter-enclosure optical links, the greater the diversity of possible ray trajectories, and the greater the reduction of the coherence of the output THz radiation compared to that of the input THz radiation.

Returning to FIGS. 1 to 3, the optical perturbation element 106 is configured to act on the input THz radiation 108 and on the circulating THz radiation 118 to reduce the coherence of the output THz radiation 122 in addition to the coherence reduction effect provided by the multiple reflections within the cavity 110. The optical perturbation element 106 can be configured to act on various parameters or properties of the input THz radiation 108, the circulating THz radiation 118, or both. Non-limiting examples include the intensity spectrum (e.g., shape, bandwidth, center frequency or wavelength), the state of polarization, the spatial intensity distribution, the distribution of propagation directions, the phase, or any combination thereof. Various types of optical perturbation elements can be used to achieve this effect, as will be described in greater detail below. In some embodiments, measures can be taken to mitigate the effect of any additional energy losses caused by the presence of the optical perturbation element 106.

The optical perturbation element 106 can be a single optical perturbation element 106 or a plurality of optical perturbation elements 106. The optical perturbation element 106 can be configured to apply a static (or steady) perturbation or a dynamic (or time-varying) perturbation to the input THz radiation 108 and/or the circulating THz radiation 118. In some embodiments, the optical perturbation element 106 is configured to act on the input THz radiation 108 as early as its generation by the THz radiation emitter 102. For example, the optical perturbation element 106 (or one of the optical perturbation elements 106) may be integrated into the THz radiation emitter 102 and be configured to act on the emission spectrum of the input THz radiation 108, as in FIG. 4.

In some embodiments, the optical perturbation element 106 is configured to act on the input THz radiation 108 and/or the circulating THz radiation 118 after its emission by the THz radiation emitter 102, at a location along a path extending between the THz radiation emitter 102 and the optical output port 120. If the THz radiation emitter 102 is disposed inside the enclosure 104, as illustrated in FIG. 4, the optical perturbation element 106 is also disposed inside the enclosure 104, either on the inner wall 114 or at another location within the cavity 110 that intercepts the multiple-reflection path followed by the circulating THz radiation 118. If the THz radiation emitter 102 is disposed outside the enclosure 104, as in FIGS. 1 to 3, the optical perturbation element 106 may be disposed either inside or outside the enclosure 104. In the former case, the optical perturbation element 106 may be disposed on the inner wall 114 of the enclosure 104, so as to act on the circulating THz radiation 118 as the circulating THz radiation 118 is reflected off the reflective surface 116, or positioned away from the inner wall 114 of the enclosure 104, so as to act on the circulating THz radiation 118 between the multiple reflections of the circulating THz radiation 118 off the reflective surface 116. In the latter case, the optical perturbation element 106 can be provided within the optical input port 112 of the enclosure 104 or at another appropriate location along the path of the input THz radiation 108 before it enters into the enclosure 104. For example, as discussed in greater detail below, the optical perturbation element 106 can be embodied by or be a part of beam-injection optics and/or beam-shaping optics disposed along a path of the input THz radiation 108 between the THz radiation emitter 102 and the optical input port 112.

In the embodiment illustrated in FIGS. 1 to 3, the optical perturbation element 106 is embodied by a set of static optical perturbation elements disposed on the reflective surface 116 of the inner wall 114 of the enclosure 104. The optical perturbation elements 106 are configured to increase the diversity of ray trajectories within the cavity 110 and/or to change ray properties (e.g., via diffuse reflection). The optical perturbation elements 106 can include diffractive (e.g., binary or blazed diffraction gratings), optically diffusing, scattering, polarization-changing, or birefringent elements, or any combination thereof. The circulating THz radiation 118 is expected to impinge on the optical perturbation elements 106 in a random manner. The optical perturbation elements 106 may cover any suitable fraction of the reflective surface 116, going from one or more small discrete areas of the reflective surface 116 to all or nearly all of the reflective surface 116. In some embodiments, the optical perturbation elements 106 may be deposited or otherwise formed on the reflective surface 116. In other embodiments, the optical perturbation elements 106 may be formed on a surface of a plug member (e.g., shaped as a circular disk) configured for insertion in an opening formed in the enclosure 104, so as to expose the optical perturbation elements 106 to the interior of the cavity 110.

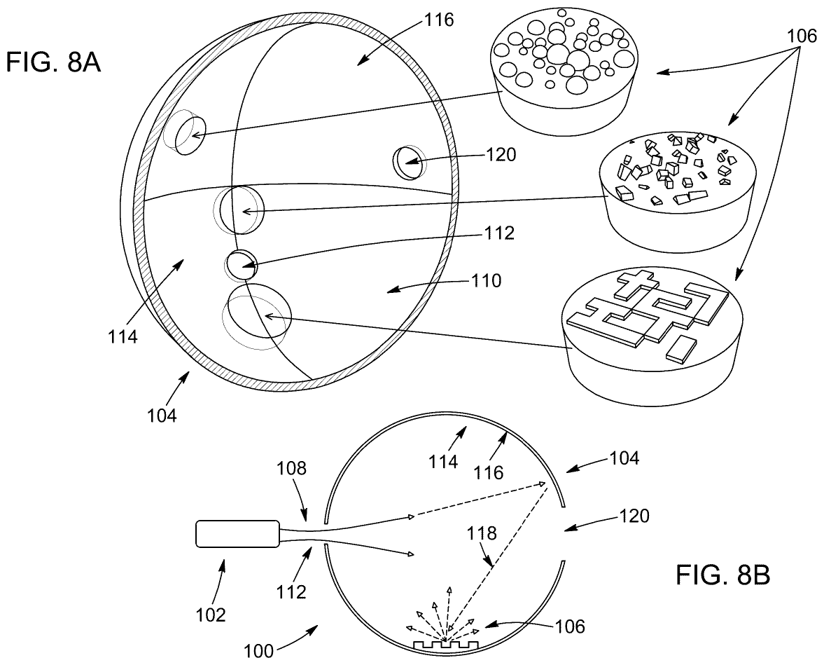

Referring to FIG. 8A, sets of randomly positioned small transparent beads (upper zoomed-in view) or chunks (middle zoomed-in view) of varying shapes and affixed to one or more regions of the inner wall 114 of the enclosure 104 are examples of static optical perturbation elements 106. These elements 106 can be made of dielectric materials transparent to THz radiation such as high-density polyethylene (HDPE), polytetrafluoroethylene (PTFE), silicon, and the like. Depending on their sizes, the beads or chunks can deflect or scatter (e.g., by Mie scattering and/or other scattering mechanisms) the THz radiation incident thereon. Referring to the lower zoomed-in view of FIG. 8A, in other embodiments one or more regions of the inner wall 114 of the enclosure 104 are covered with static optical perturbation elements 106 having a three-dimensional (3D) topography defined, for example, by two-dimensional (2D) Galois diffusers or diffusers having a chessboard pattern, as such structures can provide efficient scattering of THz radiation. Referring to FIG. 8B, in another embodiment the static optical perturbation element 106 can be embodied by a diffraction grating disposed on the inner wall 114 of the enclosure 104.

In yet other embodiments, one or more regions of the inner wall of the enclosure can include birefringent structures acting as static optical perturbation elements. For example, materials such as quartz or stressed HDPE can be cemented or otherwise mounted on the inner wall of the enclosure to form waveplates. The THz radiation impinging on and going through these waveplates before being reflected by the reflective surface can experience changes in its state of polarization. In further embodiments, retroreflectors, such as corner-cube or cat-eye retroreflectors, can be used as static optical perturbation elements, as such structures can provide additional diversity in reflection angles. In still other embodiments, other reflective and/or transmissive elements can be provided on the inner wall of the enclosure to further increase the diversity of the ray trajectories and to change the ray properties.

In some embodiments, the output THz radiation 122 is composed of beams (or rays) with various states of polarization and intensities and having traveled trajectories with different path lengths. The purpose is to have a large number of such beams with a broad distribution of different characteristics in order to achieve conditions under which the output THz radiation 122 produced by the THz illumination source 100 exhibits a fully developed speckle pattern at the exit of the source. In embodiments where the THz illumination source includes static optical perturbation elements only, the speckle pattern is expected to be static as well. It is noted that since coherence represents the capability of an optical beam to produce interference effects, the production of speckle patterns is expected to reduce the capability to produce sharp structured interference fringes, and this can be interpreted as a sign that the coherence of the output THz radiation 122 has been reduced. In other embodiments, the use of dynamic optical perturbation elements can produce time-varying changes in the speckle pattern. If the changes are sufficiently fast that a large number of distinct speckle patterns are produced during the exposure time of an image sensor used with the THz illumination source, the otherwise granular aspect of the speckle pattern associated with the output THz radiation can be reduced in, or even suppressed from, the images captured by the image sensor. The reduction or suppression of speckle patterns can be interpreted as a sign that the coherence of the output THz radiation has been reduced.

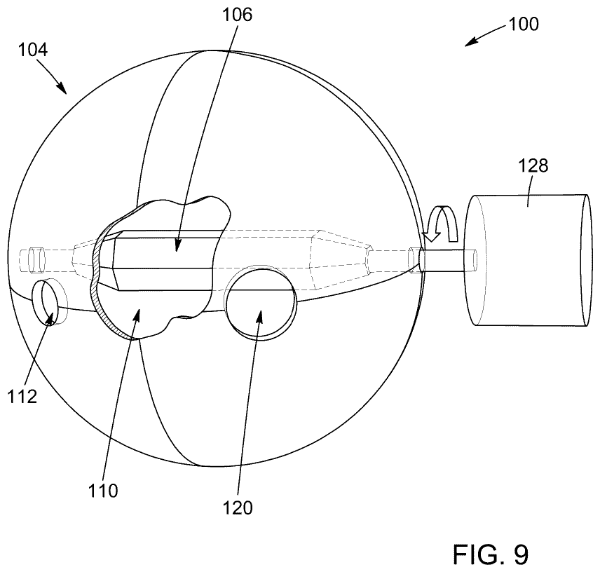

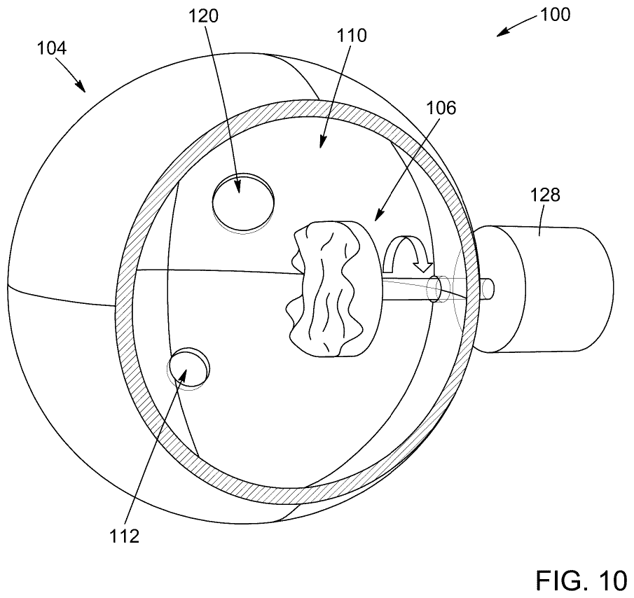

Non-limiting examples of dynamic optical perturbation elements 106 that can be used for reducing speckle artifacts and other forms of coherence-related noise include, to name a few, oscillating or rotating mirrors, either single-faceted or multifaceted; oscillating or rotating diffractive or optically diffusing elements; vibrating reflective membranes; and oscillating or rotating elements made of isotropic or anisotropic transparent materials. FIG. 9 depicts an example of a dynamic optical perturbation element 106 embodied by a rotating mirror having a hexagonal prism body and a rotation axis perpendicular to its hexagonal cross-section, and FIG. 10 depicts an example of a dynamic optical perturbation element 106 embodied by a rotating transmissive or reflective disk-shaped optical element having arbitrarily or randomly shaped surfaces. The multifaceted hexagonal mirror of FIG. 9 and the disk-shaped optical element of FIG. 10 can be driven into rotation by a motor 128, for example an electric motor, or by another suitable driving device. In FIGS. 9 and 10, the dynamic optical perturbation element 106 is positioned inside the cavity 110, and the enclosure 104 has been partially cutaway to expose the optical perturbation element 106. In other embodiments, the dynamic optical perturbation element 106 may be located at any other location inside the enclosure 104 that crosses the paths followed by the input THz radiation and/or the circulating THz radiation between the optical input port 112 and the optical output port 120.

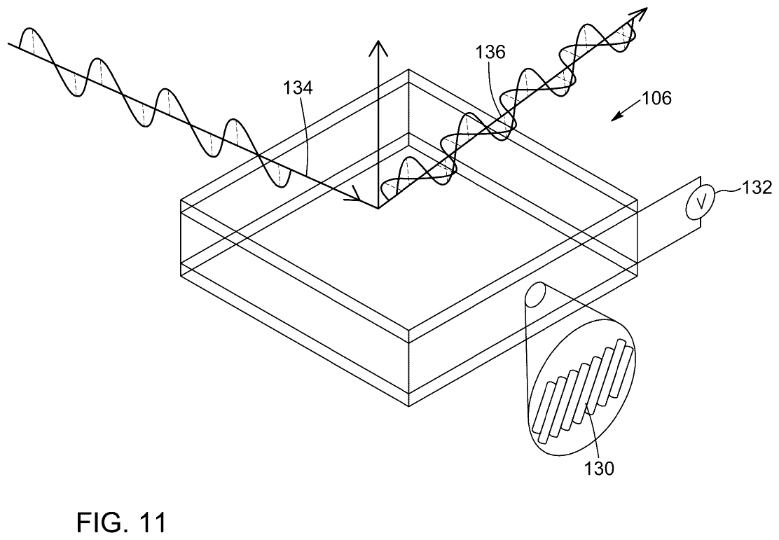

Referring to FIG. 11, another way to dynamically change the properties of a reflected ray, such as its phase or reflection angle, is by using a liquid-crystal layer including liquid crystal molecules 130 as a dynamic optical perturbation element 106. The birefringence properties of such a layer can be changed in time by the application of a time-varying and spatially varying electric field to the liquid-crystal layer via an electrical source 132. FIG. 11 depicts that an optical perturbation element 106 embodied by a liquid-crystal layer can reflect linearly polarized light 134 incident thereon as elliptically polarized light 136.

In yet other embodiments, various types of active elements having electrically controllable optical properties, including metasurfaces and metamaterials, can be used as dynamic optical perturbation elements 106. Such elements can be mounted within the cavity, on the inner wall of the enclosure, in dedicated openings formed in the enclosure, in inter-enclosure optical links, or at any other suitable locations. The motion of the dynamic optical perturbation elements can be controlled by various devices, such as simple rotating motors and vibrating actuators (e.g., piezoelectric actuators and voice coils).

In some embodiments, a dynamic optical perturbation element 106 can be built or otherwise integrated into the THz radiation emitter 102 to act on the emission spectrum of the input THz radiation 108, as schematically depicted in FIG. 4. In some embodiments, the optical perturbation element 106 is configured to apply a dynamic optical perturbation to a drive signal of the THz radiation emitter 102. For example, the optical perturbation element 106 may be configured to modulate the drive signal of the THz radiation emitter 102 so as to dynamically sweep a center frequency of the input THz radiation 108 over a range of frequencies. It is appreciated that the phase change of a light beam propagating over a given optical path length depends on the wavelength, and so does its speckle pattern. In some embodiments, a sufficiently fast sweeping of the center wavelength of the input THz radiation 108 can produce time-varying speckle patterns. In such embodiments, the effective illumination pattern captured by an image sensor corresponds to the average of the different speckle patterns generated during the exposure time of the sensor. This approach to speckle suppression can reduce the effective coherence of the output THz radiation 122, and may even eliminate it if the scanned wavelength range is large enough and the scanning rate is high enough to produce a sufficiently large number of distinct speckle patterns during the exposure time. It is appreciated that the coherence of the output THz radiation 122 can be evaluated based on the level of coherence noise per unit area (related to the pixel size of the image sensor) per unit time (related to the exposure time of the image sensor).

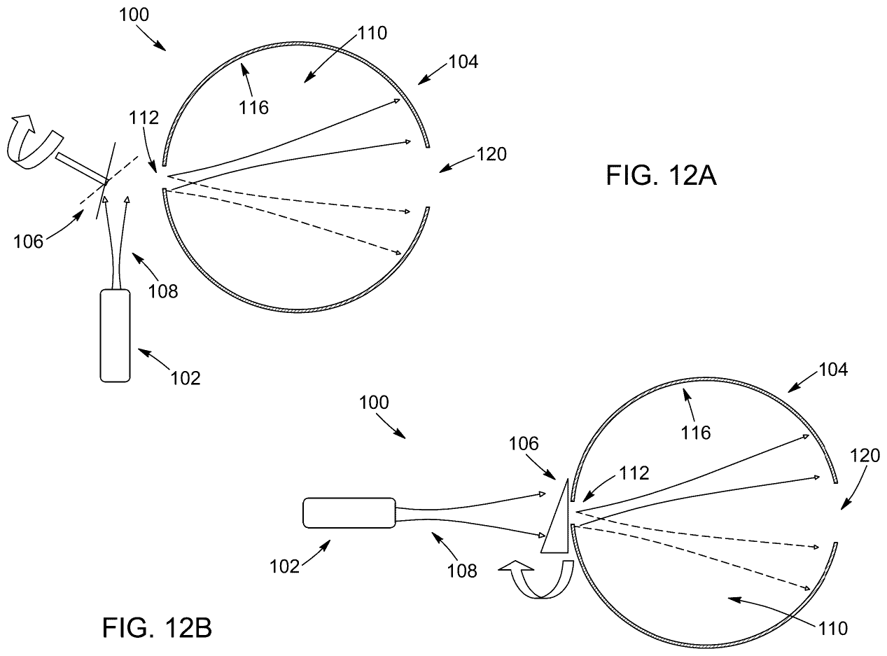

In some embodiments, dynamic optical perturbation elements 106 can be embodied by, or be part of, beam-injection optics configured to couple the input THz radiation 108 into the optical input port 112 of the enclosure 104. Non-limiting examples of beam-injection optics that can be used as dynamic optical perturbation elements 106 include, to name a few, a conical rotating, wobbling, or scanning mirror system configured to inject the input THz radiation 108 at different angles into the optical input port 112 of the enclosure 104 (see FIG. 12A); a rotating diffusing element; a rotating prism (see FIG. 12B); a counter-rotating prism pair (e.g., a Risley prism pair); a vibrating reflective membrane; and rotating or vibrating waveguiding or light pipe optics.

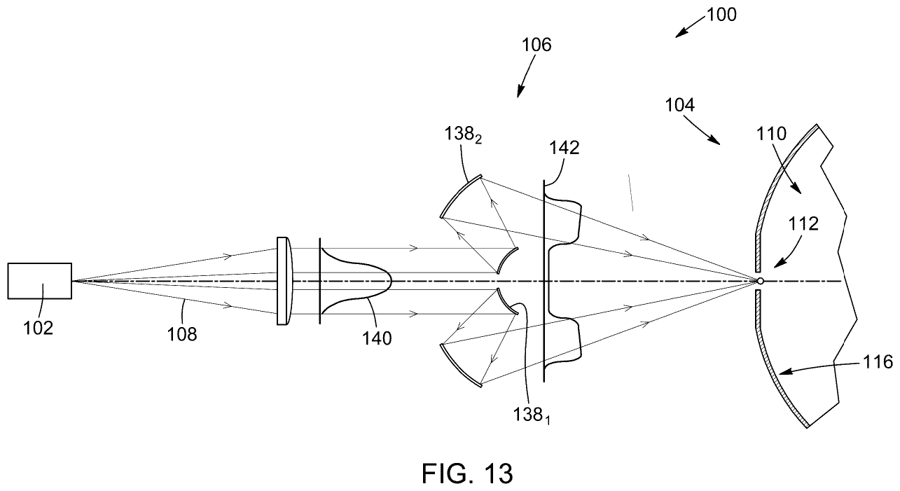

In some embodiments, the optical perturbation element can be embodied by, or be part of, beam-shaping optics configured to change the intensity and/or direction of the rays forming the input THz radiation. Beam-shaping optics that can be used as optical perturbation elements in the present techniques include various types of reflective, refractive, and diffractive beam-shaping systems, whether static or dynamic. Beam-shaping optics can be designed to perform a redistribution of the intensity and direction of rays of an optical beam. In some embodiments, such optical perturbation element can be placed inside the optical input port. Non-limiting examples of optical perturbation elements 106 embodied by static beam-shaping optics used for injection of the input THz radiation 108 on the optical input port 112 of an enclosure 104 are depicted in FIGS. 13 to 15.

FIG. 13 depicts an optical perturbation element 106 embodied by an inverse Cassegrain mirror system having a primary mirror 1381 and a secondary mirror 1382. The inverse Cassegrain mirror system is configured to receive a beam of input THz radiation 108 having a transverse bell-shaped or the like (e.g., Gaussian) intensity profile 140 emitted by a THz radiation emitter 102. The inverse Cassegrain mirror system is also configured to transform the beam of input THz radiation 108 into a hollow cone of radiation converging onto an optical input port 112 of an enclosure 104 of a THz illumination source as disclosed herein. The intensity distribution 142 on any cross sections of the cone of radiation can be uniform, increasing or decreasing outwardly, or it can have various rotationally symmetrical profiles.

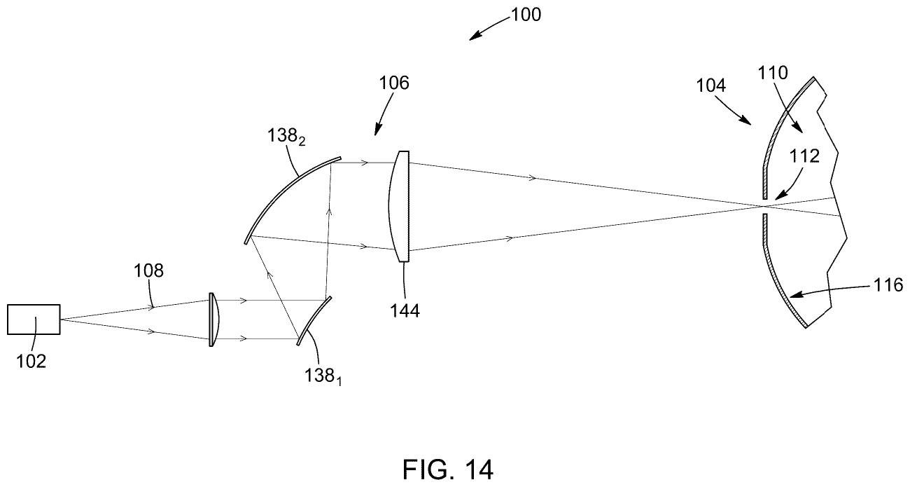

FIG. 14 depicts an optical perturbation element 106 embodied by a two-mirror system having a primary mirror 1381 and a secondary mirror 1382. The two-mirror system is configured to receive a beam of input THz radiation 108 having a transverse bell-shaped or the like (e.g., Gaussian) intensity profile emitted by a THz radiation emitter 102. The two-mirror system is also configured to transform the beam of input THz radiation 108 into a flat-top collimated beam, which is then focused by a focusing lens 144 onto an optical input port 112 of an enclosure 104 of a THz illumination source as disclosed herein.

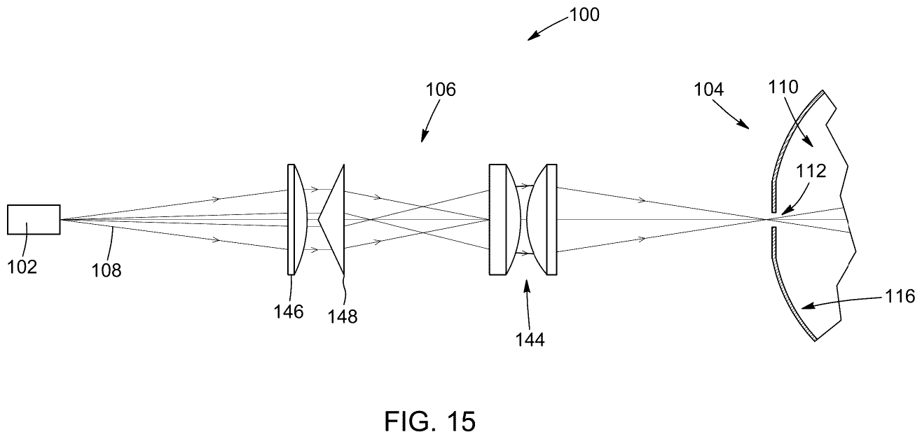

FIG. 15 depicts an optical perturbation element 106 embodied by beam-shaping optics configured to produce a hollow cone of radiation and including a collimation lens 146, an axicon 148, and focusing lenses 144. The optical perturbation element 106 can be used to produce a hollow cone of radiation for injection into an optical input port 112 of an enclosure 104 of a THz illumination source as disclosed herein. In other embodiments, diffractive optics can be used instead of an axicon to produce a hollow cone of light.

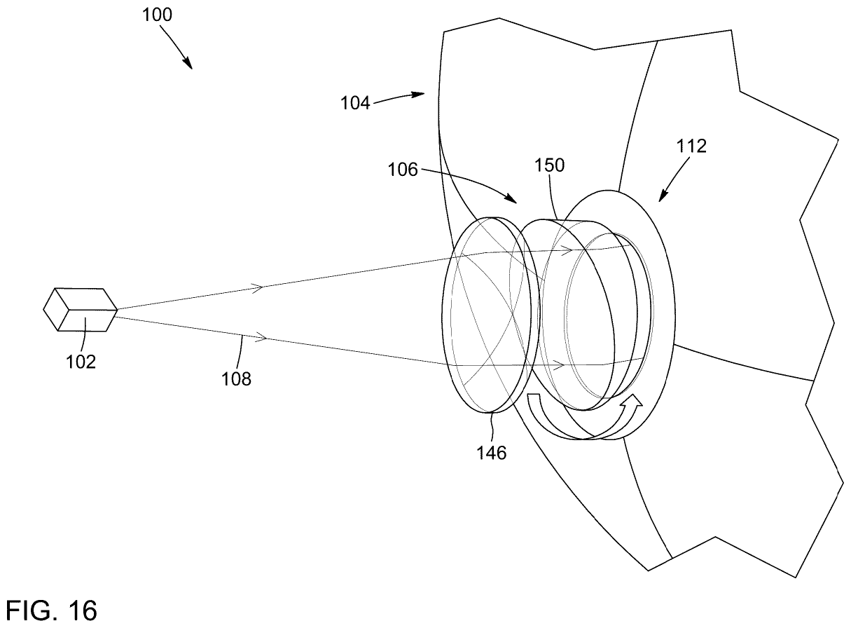

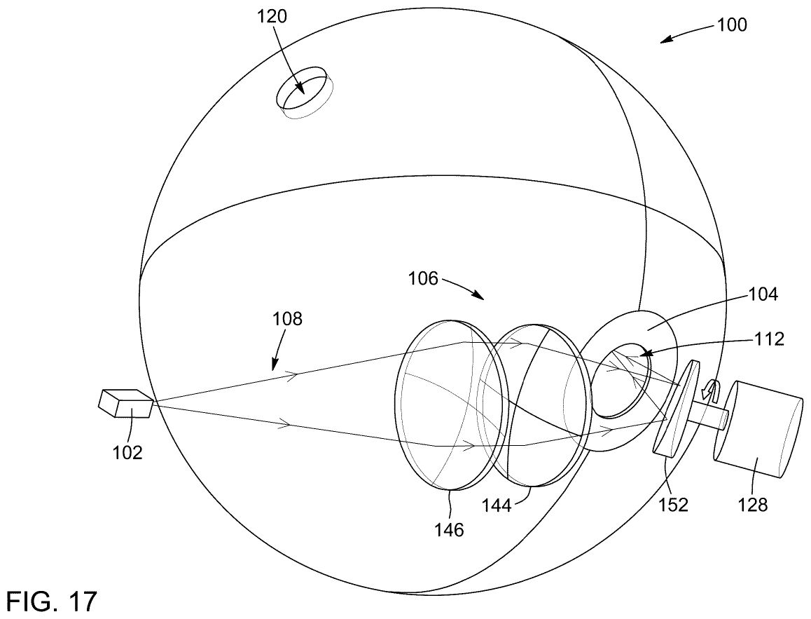

Other approaches involving the motion of beam-shaping optics are contemplated to favor multiple reflections of the input THz radiation 108 inside the enclosure 104. An example of such an approach is illustrated in FIG. 16, which depicts an optical perturbation element 106 including a rotating wedged refractive element 150 (e.g., a prism) configured to steer light away from its direct rotation axis. A similar effect can be obtained with an optical perturbation element 106 including a wobbling rotating mirror 152, such as illustrated in the conical scanning mirror system depicted in FIG. 17.

In some embodiments, the use of optical waveguides is another option for coupling the coherent or partially coherent input THz radiation into the cavity of the enclosure. Many types of THz radiation emitters includes a THz radiation source assembled or packaged within a housing having an output waveguide flange configured for connection to other optical waveguide components. Non-limiting examples of such components include hollow metallic rectangular waveguides of various standard and non-standard sizes and configured to operate at different wavelengths. In some embodiments, the output waveguide flange may be directly attached to the optical input port of the enclosure. In other embodiments, an intermediate waveguide section connected to the output waveguide flange may be machined or otherwise mounted to the optical input port to provide an optical link between the THz radiation emitter and the cavity of the enclosure. A benefit of using a waveguide-based approach to couple the input THz radiation into the cavity is that the size of the optical input port can be made as small as the dimensions of the output port of the THz radiation emitter. For example, the standard transverse dimensions of a WR3.4 hollow rectangular waveguide configured to operate at frequencies between 220 GHz and 330 GHz are 0.864 mm×0.432 mm. Such dimensions are significantly smaller than the dimensions of a typical optical input port configured to allow free-space coupling of input THz radiation (e.g., a Gaussian beam) inside the enclosure without clipping. FIG. 18 depicts an embodiment of a low-coherence THz illumination source 100 including a THz radiation emitter 102 having a housing 154 and an output waveguide flange 156, and an enclosure 104 having optical input ports 1121-1123 configured for coupling to the output waveguide flange 156, either directly (i.e., for optical input port 1122) or indirectly (e.g., via an input optical waveguide 124 for optical input port 1121). In some embodiments, another advantage of using THz radiation emitters having a waveguide output port compared to directional antennas is that the former can emit the input THz radiation with a higher beam divergence at the optical input port of the enclosure, which in turn can help reduce the coherence of the output THz radiation.

For enclosures such as described herein, the fraction of the THz radiation injected into the cavity that escapes from the cavity via the optical output port depends on the ratio of the size of the optical output port to the size of the optical input port as well as on other factors such as the reflectivity of the reflective surface of the inner wall of the enclosure. Typically, the larger the size ratio, the greater the amount of light output. In embodiments using, for example, a THz radiation emitter having a waveguide output port coupled to the optical input port of the enclosure, the cross-sectional area of the optical input port can be smaller, and preferably significantly smaller, than the cross-sectional area of the optical output port, so that the amount of light exiting the cavity through the optical input port rather than through the optical output port can be reduced. In such embodiments, the amount of light leaving the cavity via the optical input port can be reduced not only due to the relatively small size of the optical input port, but also due to the fact that the angle of incidence of the light incident on the optical input port should be within the range of acceptance angles of the input optical waveguide connected thereto. Otherwise, light is not coupled into the waveguide and is reflected into the cavity. In some embodiments, an additional device may be provided at the output of the input optical waveguide (i.e., in the optical input port of the enclosure) to further reduce the amount of light that could return into the input optical waveguide.

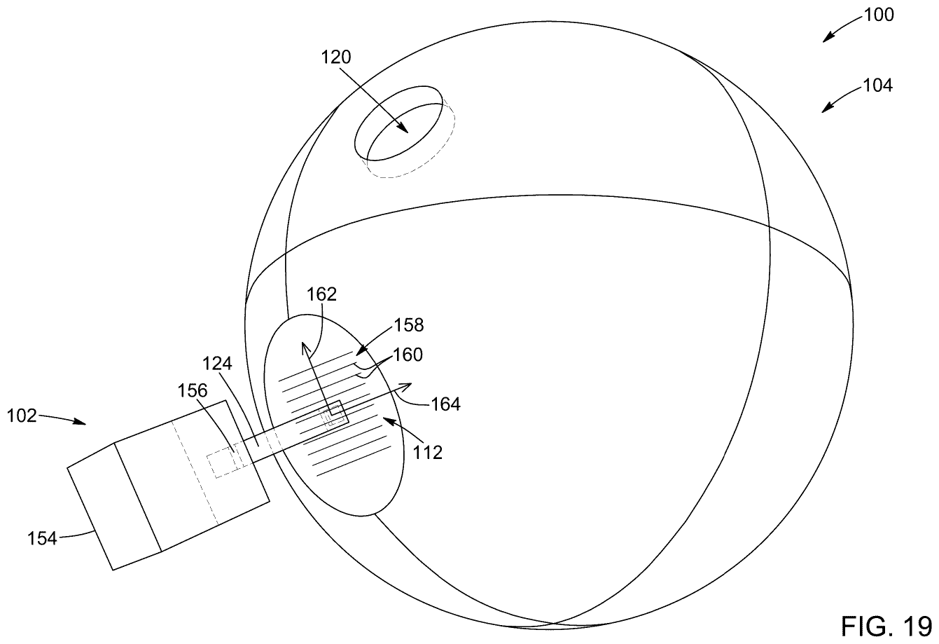

Referring to FIG. 19, a possible example of such a device is a polarizer 158 operating at THz frequencies. The polarizer 158 can be made of a grid of electrically-conducting wires 160 arranged on a substrate transparent to THz radiation. Such a polarizer 158 is configured to transmit light polarized perpendicular to the wire axis (i.e., along a transmission axis 162) and to reflect light polarized parallel to the wire axis (i.e., along a reflection axis 164). The fundamental mode of rectangular hollow waveguides is also mostly linearly polarized. Typically, the fundamental mode is a transverse electric (TE) mode, whose polarization is along the smallest transverse dimension of the rectangular waveguide. In such embodiments, a polarizer 158 having its transmission axis 162 parallel to the polarization direction of the fundamental TE mode (i.e., along the smallest waveguide dimension as in FIG. 19) can be placed in front of the optical input port 112, so that the input THz radiation incident on the polarizer 158 from the input optical waveguide 124 is transmitted into the enclosure 104 by the polarizer 158. In contrast, the state of polarization of the circulating THz radiation is expected to change appreciably after multiple reflections off the reflective surface of the inner wall of the enclosure 104. Thus, any polarization component of the circulating THz radiation oriented along the reflection axis 164 of the polarizer 158 will be reflected back by the polarizer 158 and prevented from unwantedly exiting the cavity through the optical input port 112. It is appreciated that the approach of using a polarizer in front of the optical input port to prevent unwanted escape of light from the cavity can also be implemented in embodiments using free-space coupling to the optical input port.

Another advantage of using waveguides for coupling light into the enclosure is the fact that many standard waveguide components can be interposed between the THz radiation emitter and the optical input port to provide different functions. Non-limiting examples of such waveguide components include, to name a few, optical isolators, voltage-controlled attenuators, and phase shifters, which are components that can act as optical perturbation elements to dynamically change the phase of the input THz radiation before it enters into the enclosure.

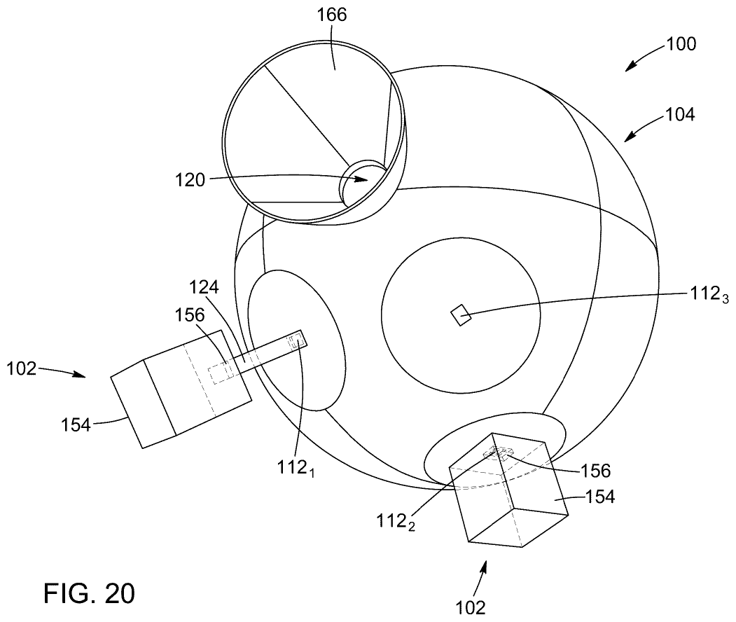

The optical input port and the optical output port can each have a variety of shapes, for example, circular, elliptical, rectangular, or any other suitable shapes. In some embodiments, the optical output port can be engineered to enhance the optical power of the output THz radiation. In general, the output THz radiation is expected to have a broad distribution of propagation directions due to its low coherence. In some embodiments, it may be desirable to condition the output THz radiation to fulfill specific illumination requirements, which can be achieved using certain beam-shaping and/or collecting optics. In some embodiments, the output THz radiation can be shaped using non-imaging optical components, such as compound parabolic concentrators (CPC), light pipes, and freeform mirrors. FIG. 20 depicts an example of a THz illumination source 100 including an enclosure 104 provided with an inverted CPC 166 at its optical output port 120.

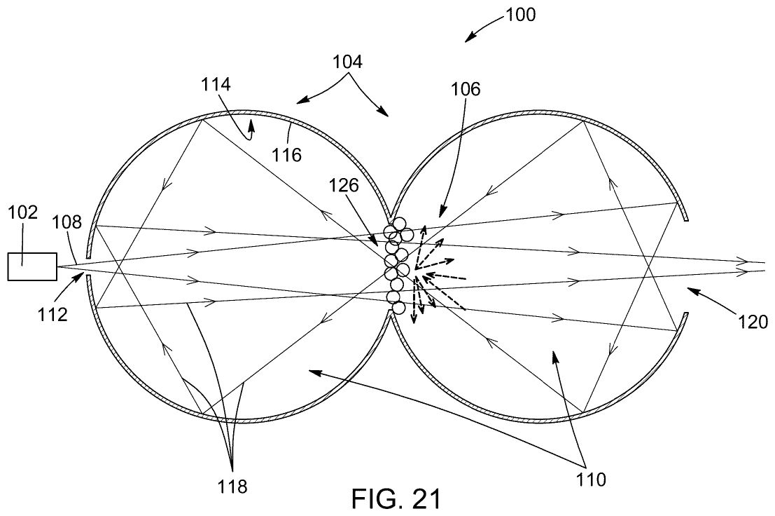

Referring to FIG. 21, in some embodiments inter-enclosure optical links 126 such as optical interfaces and waveguides may include one or more static or dynamic optical perturbation elements 106 such as those described above. Non-limiting examples of optical perturbation elements 106 that can be used within inter-enclosure optical links 126 include scattering optics, diffractive optics, and polarization-shifting waveplates.

In some embodiments, the THz illumination sources disclosed herein generate output THz radiation that cannot be focused to a diffraction-limited spot, and that can thus be considered as incoherent, nearly incoherent, or partially coherent extended light sources. In such embodiments, the THz illumination source can illuminate a scene with rays having a broad distribution of propagation directions and a large variety of states of polarization and phases. These illumination light characteristics can prevent the formation of structured fringes, and thus generally reduce coherence. In some embodiments, the THz illumination sources disclosed herein can allow THz images to be acquired that share many features with images as perceived by the human visual system in natural environment conditions, except for the lower resolution due to the longer wavelengths of THz radiation.

In some embodiments, a portion of the output THz radiation can be fed into the THz radiation emitter, either intentionally or not, which can cause random instabilities in the THz radiation emitter and therefore induce phase, direction, or mode variations in the input THz radiation.

In some embodiments, the optical perturbation element can be integrated in an antenna or waveguide coupled to the THz radiation emitter. Since the characteristics of the THz radiation beam produced by an antenna or a waveguide can be quite sensitive to the construction and configuration of its components, it is thus expected that making small modifications to the internal surface or to other components of the antenna or waveguide can produce significant modifications to the emitted beam. For example, high-frequency deformations of the internal surface of an antenna or waveguide can be obtained with a properly-driven voice coil or piezoelectric actuator.

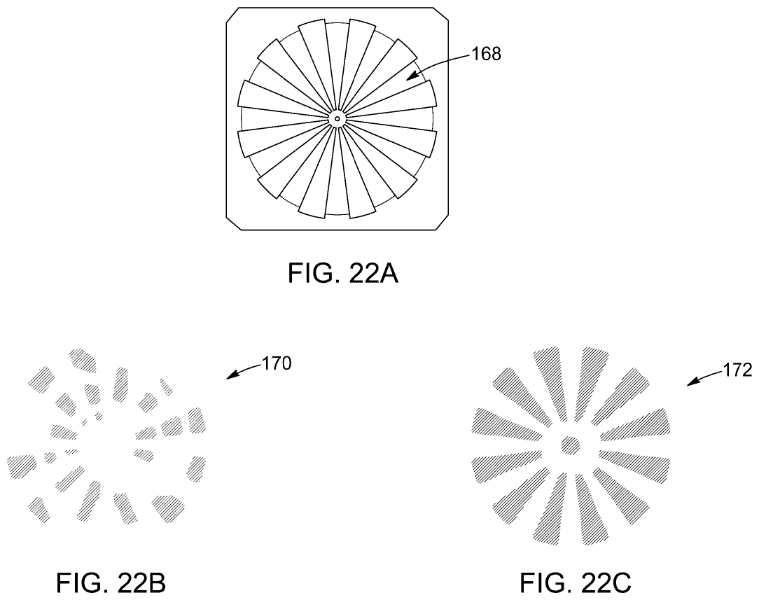

Referring to FIGS. 22A to 22C, there is provided an example illustrating certain imaging capabilities of an embodiment of a THz illumination source. The example uses a resolution target 168 having a Siemens star pattern, as depicted in FIG. 22A, which represents the image of the resolution target 168 that would be captured using an image sensor sensitive to visible light. FIG. 22B is a representation 170 of an image of the resolution target 168 captured with the target 168 illuminated by a coherent THz illumination source. It is seen that there is a notable reduction in image quality under coherent THz illumination due to speckle and other coherence-induced artifacts caused by not avoiding imaging optics imperfections, which prevents accurate imaging of the target 168. FIG. 22C is a representation 172 of an image of the resolution target 168 captured with the target 168 illuminated by a low-coherence THz illumination source in accordance with an embodiment. The image of FIG. 22C exhibits significant improvement in image interpretability and overall quality compared to the image of FIG. 22B. The images were obtained using the same imaging system, but operated in different modes. The THz illumination source used to obtain the image of FIG. 22C includes a monochromatic THz radiation emitter configured to emit coherent input THz radiation, an enclosure forming a reflective spherical cavity, and a dynamic optical perturbation element disposed within the cavity and embodied by a rotating mirror having a hexagonal prism body, such as the one depicted in FIG. 9. The enclosure includes an optical input port configured to couple the input THz radiation into the cavity, and an optical output port configured to allow a portion of the circulating THz radiation to exit from the cavity as output THz radiation after multiple reflections within the cavity. The output THz radiation has a reduced coherence compared to that of the input THz radiation and is used to illuminate the resolution target during image capture. The image representation 170 of FIG. 22B was obtained using the same THz illumination source and optical configuration as those used to obtain the image representation 172 of FIG. 22C, except that the mirror disposed within the cavity remained stationary during image capture. It is noted that images similar to that depicted in FIG. 22C were obtained using the same THz illumination source with the mirror kept stationary and a dynamic perturbation applied to the THz radiation emitter by sweeping its center frequency within a spectral band of approximately 10 GHz bandwidth.

In some embodiments, a plurality of low-coherence THz illumination sources emitting at the same frequency can be combined to provide a more powerful THz illumination system. In other embodiments, a plurality of low-coherence THz illumination sources emitting at two or more frequencies can be combined for use in multispectral THz applications. For example, dual-frequency or dual-waveband low-coherence THz illumination sources can be useful in security and inspection applications. As used herein, the term “waveband” refers to scenarios in which the emission frequency is swept over a significant range of frequencies during the exposure time of a THz camera used with the THz illumination source. In THz imaging, a tradeoff is often made between good penetration and high resolution. The lower the THz frequency, the better the penetration (due to less absorption or scattering), but the lower the resolution (due to diffraction). Conversely, the higher the THz frequency, the higher the resolution, but the more limited the penetration (e.g., higher THz frequencies may have difficulty penetrating through certain materials due to their thickness and/or composition). Thus, a THz imaging system capable of imaging at two or more frequencies, or within two or more distinct wavebands, can allow more information to be extracted than with single-frequency or single-waveband systems. In some embodiments, a THz illumination system having a continuous illumination spectrum over a broad frequency range may be obtained by combining a plurality of low-coherence THz illumination sources having partially overlapping swept frequency ranges.

Numerous modifications could be made to the embodiments described above without departing from the scope of the appended claims.

1. A low-coherence THz illumination source comprising:
a THz radiation emitter configured to emit input THz radiation:
an enclosure forming a cavity optically coupled to the THz radiation emitter, the enclosure comprising:
an inner wall enclosing the cavity and having a reflective surface configured to reflect the input THz radiation within the cavity as circulating THz radiation; and
an optical output port configured to allow a portion of the circulating THz radiation to exit from the cavity as output THz radiation after multiple reflections off the reflective surface, the output THz radiation having a reduced coherence compared to a coherence of the input THz radiation; and
an optical perturbation element configured to act on the input THz radiation or the circulating THz radiation to contribute, along with the multiple reflections off the reflective surface, to achieving the reduced coherence of the output THz radiation.

2. The low-coherence THz illumination source of claim 1, wherein the THz radiation emitter is located inside the cavity.

3. The low-coherence THz illumination source of claim 1, wherein the THz radiation emitter is located outside the cavity, and wherein the enclosure further comprises an optical input port optically coupled to the THz radiation emitter and configured to allow the input THz radiation to enter into the cavity.

4. The low-coherence THz illumination source of claim 3, wherein a cross-sectional area of the optical input port is smaller than a cross-sectional area of the optical output port.

5. The low-coherence THz illumination source of claim 3, further comprising an input optical waveguide configured to couple the input THz radiation emitted by THz radiation emitter into the optical input port.

6. The low-coherence THz illumination source of claim 3, further comprising a polarizer arranged in the cavity in front of the optical input port and having a reflection axis, the polarizer being configured to prevent a polarization component of the circulating THz radiation oriented along the reflection axis from exiting the cavity through the optical input port.

7. The low-coherence THz illumination source of claim 3, wherein the optical perturbation element comprises beam-injection optics or beam-shaping optics disposed outside the enclosure along a path of the input THz radiation between the THz radiation emitter and the optical input port.

8. The low-coherence THz illumination source of claim 1, wherein the optical perturbation element is located inside the enclosure.

9. The low-coherence THz illumination source of claim 8, wherein the optical perturbation element is disposed on the inner wall of the enclosure to act on the circulating THz radiation as the circulating THz radiation is reflected off the reflective surface.

10. The low-coherence THz illumination source of claim 8, wherein the optical perturbation element is positioned away from the inner wall of the enclosure to act on the circulating THz radiation between the multiple reflections of the circulating THz radiation off the reflective surface.

11. The low-coherence THz illumination source of claim 10, wherein the optical perturbation element comprises a movable mirror.

12. The low-coherence THz illumination source of claim 1, wherein the optical perturbation element is one of a plurality of optical perturbation elements.

13. The low-coherence THz illumination source of claim 1, wherein the enclosure is spherical.

14. The low-coherence THz illumination source of claim 1, wherein the enclosure is one of a plurality of enclosures and the cavity is one of a plurality of cavities formed by the plurality of enclosures, and wherein the low-coherence THz illumination source comprises at least one inter-enclosure optical link for optically connecting the cavities together.

15. The low-coherence THz illumination source of claim 14, wherein the at least one inter-enclosure optical link comprises an inter-enclosure optical waveguide.

16. The low-coherence THz illumination source of claim 1, wherein the optical perturbation element is configured to apply a static optical perturbation to the input THz radiation or the circulating THz radiation.

17. The low-coherence THz illumination source of claim 1, wherein the optical perturbation element is configured to apply a dynamic optical perturbation to the input THz radiation or the circulating THz radiation.

18. The low-coherence THz illumination source of claim 17, wherein the optical perturbation element is configured to apply the dynamic optical perturbation to a drive signal of the THz radiation emitter.

19. The low-coherence THz illumination source of claim 18, wherein the optical perturbation element is configured to modulate the drive signal of the THz radiation emitter to dynamically sweep a center frequency of the input THz radiation over a range of frequencies.

20. The low-coherence THz illumination source of claim 1, wherein the optical perturbation element is configured to act on at least one of an intensity spectrum, a state of polarization, a distribution of propagation directions, or a phase of the input THz radiation or the circulating THz radiation.
